(19) United States
(12) Patent Application Publication
(10) Pub. No.: US 2021/0323875 A1
(43) Pub. Date: Oct. 21, 2021

(54) Short-Fiber-Reinforced Oriented MAX-Phase Ceramic-Based Composite and Preparation Method Therefor

(71) Applicant: Institute of Metal Research Chinese Academy of Sciences, Shenyang City, Liaoning Province (CN)

(72) Inventors: Qing JIA, Shenyang (CN); Xi XIE, Shenyang (CN); Chunguang BAI, Shenyang (CN); Yuyou CUI, Shenyang (CN); Rui YANG, Shenyang (CN)

(21) Appl. No.: 17/272,348

(22) PCT Filed: Aug. 19, 2019
(86) PCT No.: PCT/CN2019/101343

§ 371 Date: Feb. 28, 2021

(30) Foreign Application Priority Data
Aug. 31, 2018 (CN) 201811006675.1

(51) Int. Cl. C04B 35/56; C04B 35/64

(52) U.S. Cl. CPC C04B 35/5618; C04B 35/64; B82Y 30/00; C04B 2235/6567; C04B 2235/6562

(57) ABSTRACT

The present invention relates to the field of MAX-phase ceramic-based composites, specifically to a short-fiber-reinforced oriented MAX-phase ceramic-based composite and a preparation method therefor. By using a new process with a fiber, a nano lamellar MAX-phase ceramic powder, other additives, etc., for preparing a fiber-reinforced MAX-phase ceramic-based composite, a novel ternary composite is prepared, wherein a matrix is composed of a highly oriented lamellar MAX-phase ceramic, the fiber is distributed parallel to the lamellar MAX-phase ceramic in an axial direction, and a granulate ceramic phase enhancement phase is dispersed in the matrix. Thus, the problems of a MAX-phase ceramic-based composite matrix material prepared by an existing method, such as coarse grains, multiple internal defects and a low strength, and a poor fracture toughness; and a reaction sintering temperature being too high such that fibers are chemically and physically damaged in a substrate, resulting in performance degradation, are solved. Fibers prepared by the method are suitable for large-scale industrial preparation and have properties that are far superior to those of any existing known fiber MAX-phase composite.

### FIELD OF INVENTION

The present invention relates to the field of MAX-phase ceramic matrix composite materials, in particular to a MAX-phase ceramic matrix composite material with short fiber reinforced orientation and a preparation method thereof.

### DESCRIPTION OF RELATED ARTS

MAX-phase ceramic materials (such as Ti₃SiC₂, Ti₂AlC, Nb₂AlC, and etc.) are used as ceramic materials with a room temperature fracture toughness of about 6-8 MPa.m^{1/2}. At the same time, they have characteristics such as high structural strength, oxidation resistance, thermal corrosion resistance, radiation resistance, damage self-healing and etc. The maximum operating temperature of certain types reaches 1700° C. However, its strength and hardness are far lower than traditional ceramics such as Al₂O₃, TZP, YAG, its brittleness level is great, and its reliability at room temperature is lower than traditional metal materials. In order to improve its strength, hardness, and toughness, the strengthening of the second phase particles (such as SiC, Al₂O₃, Ti₅Si₃, TiB₂, W) and the solid solution strengthening of Nb, Si, N and other elements have been tried already. When the second phase particle content is about 10% by mass fraction, the toughness of the composite material reaches the maximum value of 8˜9 MPa.m^{1/2}. However, at the particle content of about 10 wt %, the improvement of strength, hardness and toughness is limited, and the toughness drops sharply after exceeding the critical content level. Moreover, most of the second phase particles of the particle-strengthened MAX-phase material exist in the grain boundaries, and the material grain boundaries contain pores and microcracks. These defects are good channels for crack initiation and crack propagation for material damage. Therefore, it is necessary to explore new strengthening methods. As a ceramic matrix composite material, the method of strengthening and toughening the fiber matrix with higher performance is not sufficient in the field of MAX-phase materials. This may be related to the reaction of most of the fibers during the sintering process of MAX-phase materials.

The increase in the toughness of ceramic materials also means the increase in resistance to crack propagation in the material. The main method is to set up a mechanism that can hinder the crack propagation in the ceramic material to increase the energy required for crack propagation. Wherein solid solution strengthening and particle strengthening have been by existing work and proved to have no significant toughening effect. The method of fiber toughening can make the weak interface of the fiber matrix debond during the crack propagation process, and the crack deflection and crack propagation energy is absorbed. As the material is having further destruction, there will be processes such as fiber bridging, fiber breakage and fiber pull-out. The interaction between the fiber and the matrix in these processes will reduce the crack growth rate.

### SUMMARY OF THE PRESENT INVENTION

An object of the present invention is to provide a MAX-phase ceramic matrix composite material with short fiber reinforced orientation and a preparation method thereof, which can solve the existing problems that the temperature of the synthesis reaction of ceramic matrix composites is very high in the method for preparing fiber MAX-phase composite material, the MAX-phase matrix material synthesized by the reaction has very coarse grains, many internal defects, low strength, and poor fracture toughness; and the reaction sintering temperature is too high for the fiber, and the chemical and physical loss of the fiber in the base material leads to problems such as performance degradation.

The technical solution of the present invention is:

A MAX-phase ceramic matrix composite material with short fiber reinforced orientation, the MAX-phase ceramic matrix composite material is prepared by a sintering method and has the following characteristics: the matrix formed by the nanosheet layered MAX-phase ceramics is highly oriented, the short fibers which are used for reinforcement are distributed in the MAX-phase ceramic matrix, the axial direction of short fibers is parallel to the nanosheet layered MAX-phase ceramics.

In the MAX-phase ceramic matrix composite material with short fiber reinforced orientation, the short fiber adopts a short fiber obtained by direct chemical synthesis, a continuous fiber with chopped cut treatment or raw cotton that can be directly stirred into short fiber, wherein the short fiber obtained by direct chemical synthesis is whisker or nanowire, the continuous fiber with chopped cut treatment is carbon fiber, silicon carbide fiber, glass fiber or boron fiber, and the raw cotton that can be directly stirred into short fiber is alumina fiber raw cotton or glass fiber raw cotton.

In the MAX-phase ceramic matrix composite material with short fiber reinforced orientation, the fiber diameter of the short fiber is 0.02˜100 microns, and the fiber length of the short fiber is 0.1˜5000 microns, the size of the MAX-phase nanosheet layered ceramics is 20˜400 nanometers in thickness and 0.05˜10 microns in width.

The MAX-phase ceramic matrix composite material with short fiber reinforced orientation also includes additives which are dispersed in the matrix of the MAX-phase ceramics; the additives are components that react with the MAX-phase ceramics to generate an in-situ ceramic phase, or the additives are granular ceramic components added by an external source.

In the MAX-phase ceramic matrix composite material with short fiber reinforced orientation, the components that react with the MAX-phase ceramics to generate the in-situ ceramic phase are elements C or organic matters, the granular ceramic components added by the external source are silicon carbide, alumina, aluminum nitride or titanium carbide, and a particle size of the granular ceramic components is 20˜400 nanometers.

The MAX-phase ceramic matrix composite material with short fiber reinforced orientation, in the MAX-phase ceramic matrix composite material, a mass ratio of the short fibers, the nanosheet layered MAX-phase ceramics and the additives is (0.5˜5):10:(0˜5).

A preparation method of the MAX-phase ceramic matrix composite material with short fiber reinforced orientation, using short fiber and nanosheet layered MAX-phase ceramics powder as reaction raw materials, adding additive according to the need, a mass ratio of short fibers, nanosheet layered MAX-phase ceramics and additives is (0.5˜5):10:(0˜5). The raw material is added to the organic solvent to prepare the raw material slurry, the raw material slurry is placed in a mixer or other mixing equipment and mixed uniformly, and then dried to obtain a uniformly mixed mixture material. The mixture material or an embryo body prepared by pressing the mixture material is sintered to prepare the MAX-phase ceramic matrix composite material.

The preparation method of the MAX-phase ceramic matrix composite material with short fiber reinforced orientation, a sintering method which utilizes the mixture material or the embryo body directly for sintering with pressure, or a sintering method which utilizes the mixture material or the embryo body directly for pre-pressing molding followed by sintering without pressure is employed.

In the preparation method of the MAX-phase ceramic matrix composite material with short fiber reinforced orientation, the sintering method which utilizes the mixture material or the embryo body directly for sintering with pressure employs hot pressing sintering method, hot isostatic pressing sintering method or spark plasma sintering method, wherein:

(1) the hot pressing sintering method:

the mixture material or the embryo body is directly loaded into a graphite mold, and inside the graphite mold, hot pressing sintering is carried out, the sintering temperature is 500˜2000° C., the sintering pressure is 1˜200 MPa, the holding time is 10˜3600 minutes, and the heating rate is 1˜100° C. per minute, and the sintering atmosphere is vacuum or argon atmosphere;

(2) the hot isostatic pressing sintering method:

put the mixture material or the embryo body directly into the hot isostatic pressing jacket, and then vacuum and seal the jacket; inside the jacket, carry out hot isostatic pressing sintering, the sintering temperature is 500˜2000° C., the sintering pressure is 1˜800 MPa, the holding time is 10˜3600 minutes, and the heating rate is 1 100° C. per minute, and the sintering atmosphere is vacuum or argon atmosphere;

(3) the spark plasma sintering method:

put the mixture material or the embryo body directly into the sintering mold, and apply a large pulse current for sintering, the sintering temperature is 300˜1800° C., the sintering pressure is 1˜400 MPa, the holding time is 5˜600 minutes, and the heating rate is 1˜500° C. per minute, and the sintering atmosphere is vacuum or argon atmosphere.

In the preparation method of the MAX-phase ceramic matrix composite material with short fiber reinforced orientation, the sintering method which utilizes the mixture material or the embryo body directly for pre-compression molding followed by sintering without pressure employs one of the followings:

(1) put the mixture material or the embryo body into a pressing mold, apply pressure to the mold to process densification, the pressure applied is 5˜1000 MPa, and then use the obtained pressed product of the mixture material or the embryo body to carrying out sintering without pressure;

(2) put the mixture material or the embryo body into the cold isostatic pressing jacket, and then vacuum and seal the jacket; process cold isostatic pressing sintering of the mixture material or the embryo body inside the jacket for densification, the cold isostatic pressing temperature is 0˜600° C., the cold isostatic pressing pressure is 1˜800 MPa, the holding time is 10˜3600 minutes, and the heating rate is 1˜100° C. per minute, then use the obtained pressed product of the mixture material or the embryo body from the jacket to process sintering without pressure;

(3) process sintering without pressure for the obtained pre-pressed formed of the mixture material or the embryo body, the sintering method is: put the mixture material or the embryo body into a container that can withstand the sintering temperature, and then vacuum the container or pass protective gas, or put the mixture material or the embryo body directly into a furnace body that is vacuumed or passed with protective gas to process sintering without pressure.

The equipment used for sintering is muffle furnace, induction heating furnace, microwave heating furnace, or infrared heating furnace, the sintering temperature is 300˜2000° C. and the sintering time is 10˜9600 minutes.

The design idea of the present invention is as follows:

Because the nano powder has high activity and large specific surface area, the sintering temperature can be reduced significantly. The material after the sintering process has a high density and good composition uniformity. Compared with ordinary ceramics, the strength, toughness and superplasticity of the ceramic are greatly improved. At the same time, a lower sintering temperature will reduce the reaction between the fiber and the matrix and reduce the burning loss of the fiber, which is of significant furtherance for maintaining the performance of the fiber. Moreover, the unique properties of the nano MAX-phase will cause the sintered ceramic to have a unique orientation. The present invention, through providing a method of preparing composite materials with short fiber, further improve the performance of the oriented MAX-phase ceramic matrix composite materials.

The advantageous and beneficial effects of the present invention are as follows:

1. The method of the present invention has low equipment requirement for preparing fiber reinforced MAX-phase ceramic matrix composite material, and is suitable for large-scale industrial preparation. Basically, there is no size limitation for sample preparation.

2. The composite material obtained by using oriented nano MAX-phase ceramics as the matrix material in the present invention has a performance level far exceeding any existing known fiber MAX-phase composite material.

3. The present invention uses nano powder as one of the raw materials for reaction sintering, which greatly reduces the sintering reaction temperature, reduces the thermal damage of the fiber, and retains the excellent performance of the fiber.

4. The technical routes and preparation methods of the present invention are diverse and can be used individually or in combination depending on specific equipment and other conditions, its technical adaptability is good and its portability is good.

### DESCRIPTION OF THE DRAWINGS

FIG. 1 illustrates a scanning electron microscope image of alumina fiber raw cotton according to Embodiment 1.

FIG. 2 illustrates a scanning electron microscope image of alumina fiber raw cotton which is pre-processed according to Embodiment 1.

FIG. 3 illustrates a scanning electron microscope image of an axial section of nanocomposite ceramic material fiber according to Embodiment 1.

FIG. 4 illustrates a scanning electron microscope image of an axial section of nanocomposite ceramic material fiber according to Embodiment 1.

FIG. 5 illustrates a scanning electron microscope image of a fracture section of nanocomposite ceramic material fiber according to Embodiment 1.

### DETAILED DESCRIPTION OF THE PREFERRED EMBODIMENT OF THE PRESENT INVENTION

In the implementation process of the embodiment, the present invention adopts a new process for preparing fiber-reinforced MAX-phase ceramic matrix composites by using short fiber, nanosheet layered MAX-phase ceramic powder, other additives, etc. to prepare a new ternary composite material in which a matrix is composed of highly oriented sheet layered MAX-phase ceramics, a fiber axial direction is parallel to the sheet layered MAX-phase ceramic, and a granular ceramic phase reinforcement phase is dispersed in the matrix, and the preparation steps are as follows:

(1) the raw materials used for preparation method is fiber, nanosheet layered MAX-phase ceramics powder, and other additives can be added according to the needs. The nanosheet layered MAX-phase ceramics powder, short fibers obtained by chemical synthesis or pre-treated fibers and fiber raw cotton, and other additives, etc. are weighed and proportioned.

The raw material fiber is the short fiber obtained by direct chemical synthesis (such as whiskers, nanowires, etc.), the continuous fiber with chopped cut treatment such as carbon fiber, silicon carbide fiber, glass fiber, boron fiber, etc., and the raw cotton that can be directly stirred into short fiber (such as: alumina fiber and some glass fiber raw cotton, etc.).

Other additives can be any components of additives that react with MAX-phase ceramics, such as C elements and organic matters, etc., which is used to generate in-situ ceramic phases, or any granular ceramic components of additives from an external source such as silicon carbide, alumina, aluminum nitride, titanium carbide, etc.

(2) Mix the materials with a preset ratio, according to the characteristics of the materials and the components of the target product, a suitable mixing method and mixing process are selected to prepare a dry mixture. Use short fibers, nanosheet layered MAX-phase ceramics powder and additive as reaction raw materials, preparing the reaction raw materials to a prepared raw material having a mass ratio of short fibers, MAX-phase and other additives equal to (0.5˜5):10:(0˜5). Add the prepared raw materials to an organic solvent to form a raw material slurry. Place the raw material slurry in a mixer or any other mixing equipment and mix uniformly. Then, process drying to obtain a mixture material which is uniformly mixed.

(3) The dried mixture material, or an embryo body prepared by pressing the mixture material is sintered, a suitable method of sintering with pressure or pre-pressing molding followed by sintering without pressure is selected according to the specific situation.

The method of sintering can utilize the mixture material or the embryo body directly for sintering with pressure. For example, the hot pressing sintering method is employed. The mixture material or the embryo body is directly loaded into a graphite mold, and inside the graphite mold, hot pressing sintering is carried out, the sintering temperature is 500˜2000° C., the sintering pressure is 1˜200 MPa, the holding time is 10˜3600 minutes, and the heating rate is 1˜100° C. per minute, and the sintering process can be carried out under vacuum or argon atmosphere. The hot isostatic pressing sintering method is employed. the mixture material or the embryo body are put directly into the hot isostatic pressing jacket, and then the jacket is vacuumed and sealed. Inside the jacket, the hot isostatic pressing sintering is carried out, the sintering temperature is 500˜2000° C., the sintering pressure is 1˜800 MPa, the holding time is 10˜3600 minutes, and the heating rate is 1˜100° C. per minute, and the sintering process can be carried out under vacuum or argon atmosphere. The spark plasma sintering method is employed. The mixture material or the embryo body is placed directly into the sintering mold, and a large pulse current is applied for sintering, the sintering temperature is 300˜1800° C., the sintering pressure is 1˜400 MPa, the holding time is 5˜600 minutes, and the heating rate is 1˜500° C. per minute, and the sintering process can be carried out under vacuum or argon atmosphere. The sintering method for the mixture material or the embryo body is not limited to the above is not limited to the above-listed methods. Any method of sintering with pressure that can exert an external effect on the mixture material or the embryo body to cause deformation and simultaneous sintering is within the protection scope of the present invention.

The method of sintering can utilize the mixture material or the embryo body directly for pre-pressing molding followed by sintering without pressure. For example, the mixture material or the embryo body is placed into a pressing mold, pressure is applied to the mold to cause densification, the pressure applied is 5˜1000 MPa, and then the pressed product of the mixture material or the embryo body is obtained to carrying out sintering without pressure. The mixture material or the embryo body is placed into the cold isostatic pressing jacket, and then the jacket is vacuumed and sealed, inside the jacket, cold isostatic pressing sintering is carried out for densification, the cold isostatic pressing temperature is 0˜600° C., the cold isostatic pressing pressure is 1˜800 MPa, the holding time is 10˜3600 minutes, and the heating rate is 1˜100° C. per minute. Then the pressed product of the mixture material or the embryo body is obtained and taken out from the jacket to process sintering without pressure. The pre-pressing molding of the mixture material or the embryo body is not limited to the above-listed methods. Any pressing method that can exert an external effect on the mixture material or the embryo body to cause deformation is within the protection scope of the present invention. To process sintering without pressure for the obtained pre-pressed form of mixture material or embryo, the method of sintering can be: place the powder into a container that can withstand the sintering temperature, and then vacuum or pass protective gas (such as argon) to the container, or put the powder directly into a furnace that can be used for sintering without pressure, and vacuumed or passed with protective gas to carry out sintering. The sintering equipment can be any equipment such as muffle furnace, induction heating furnace, microwave heating furnace, infrared heating furnace, etc. that can heat the sample to make it sintered and densified. The sintering temperature is 300˜2000° C. and the sintering time is 10˜9600 minutes. The method which utilizes the mixture material or the embryo body directly for pre-pressing molding followed by sintering without pressure is not limited to the methods listed above. Any sintering method that a temperature field can be applied to the powder is within the protection scope of the present invention.

Since the present invention covers a wide range of technical methods and routes, in order to help further understand the objects, solutions, and advantages of the present discoveries, a clear and complete description is further provided in conjunction with specific embodiments. At the same time, it should be pointed out that the embodiments described below are only part of the work and implementations listed, and not all the embodiments that can be realized. Any use of the technical methods within the scope of the claims of the present invention shall fall within the protection scope of the present invention.

### Embodiment 1

According to this embodiment, a preparation method of MAX-phase ceramic matrix composite material with short fiber reinforced orientation is as follows:

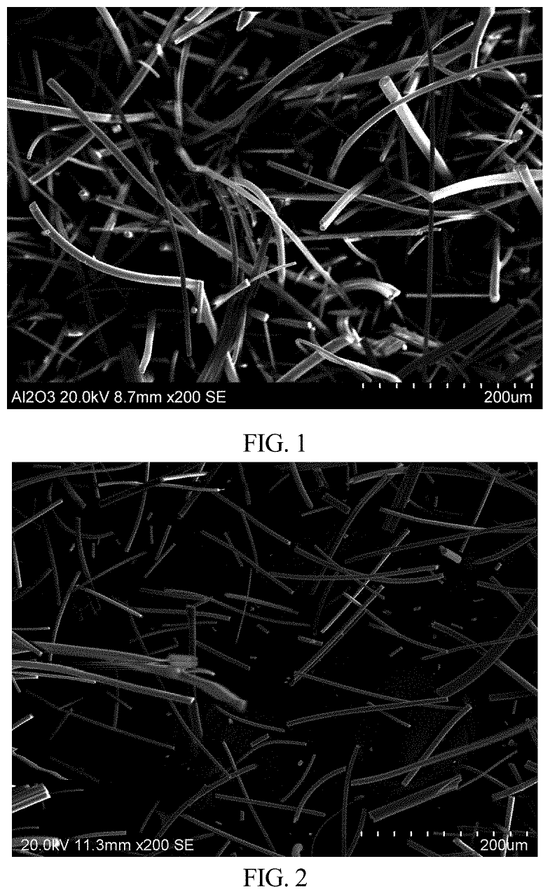

Weigh 200 grams of MAX-phase ceramic nanosheet layered powder named Ti₂AlC, the particle size of the powder is 180 nanometers, and the oxygen content of the powder is 8% by mass fraction. Weigh 40 grams of the alumina fiber raw cotton as shown in FIG. 1, and pretreat the fiber raw cotton to obtain short fibers with a fiber diameter of 3˜10 microns and a fiber length of 50˜200 microns as shown in FIG. 2. The nanosheet powder and short fibers are put into a 1 L beaker directly, and 200 g of absolute ethanol is added for electric mechanical stirring, and the speed of the stirring blade is 200 rpm. After stirring for 1 hour, the slurry is taken out and dried. After the slurry is completely dried, the obtained mixture is loaded into the mixing machine, and a small amount of polyurethane-coated iron core balls with a diameter of 10 mm are added for mixing. The mixing tank has a circular motion speed of 50 rpm, and the mixing time is 2 hours. After the mixing is completed, the polyurethane core balls are sorted out to obtain a uniformly mixture material. The mixture material is loaded into a graphite mold, and hot-pressing sintering method is employed. Inside the graphite mold, the hot-pressing sintering is carried out, the sintering temperature 1250° C., the sintering pressure is 50 MPa, the holding time is 60 minutes, and the heating rate is 5° C. per minute, and the sintering atmosphere is vacuum condition. After the sintering process, alumina fiber reinforced Ti₂AlC/Al₂O₃ nano-composite ceramics is obtained, and the content of nano alumina particles accounts for 10% of the material by mass fraction, alumina fiber accounts for 16.6% of the material by mass fraction, the rest is Ti₂AlC, the orientation of the nanosheet layered MAX-phase ceramic matrix is that the direction of the sheet layer is parallel to the sintering pressing surface, and the specification size of the nanosheet layered MAX-phase ceramic is 50˜400 nanometers in thickness and 0.5˜5 microns in width.

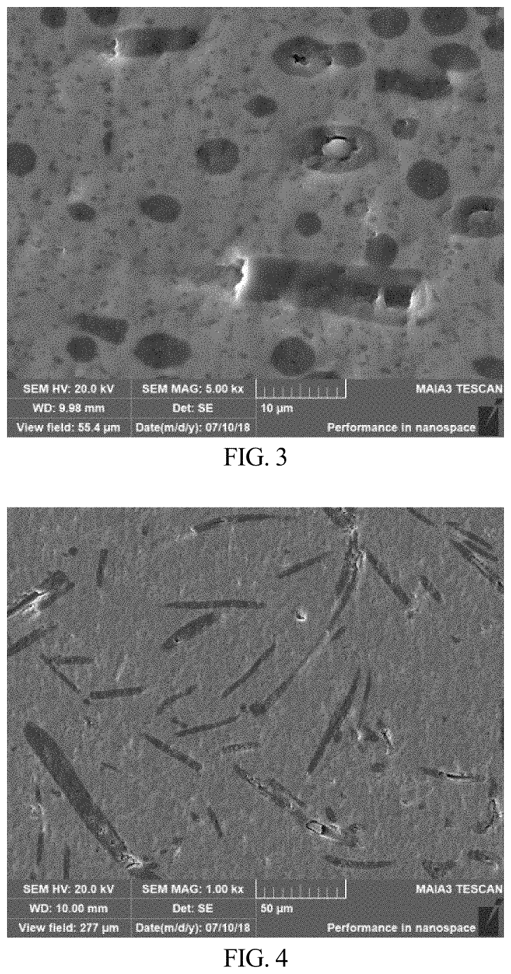

As shown in FIG. 3, it can be seen from the fiber axial section of the obtained nanocomposite ceramic material that: in the material prepared by the preparation method, the fiber in the MAX-phase matrix also have orientation, the reinforced short fibers are evenly distributed in the MAX-phase ceramic matrix, while the axial direction of the short fibers is parallel to the nanosheet layered MAX-phase ceramics. In the picture, the nano-sized dark spots are nano-alumina particles, the circular spots with a diameter of 5-10 microns are the fiber axial section of the alumina fiber, and the bright-colored substrate is Ti₂AlC phase.

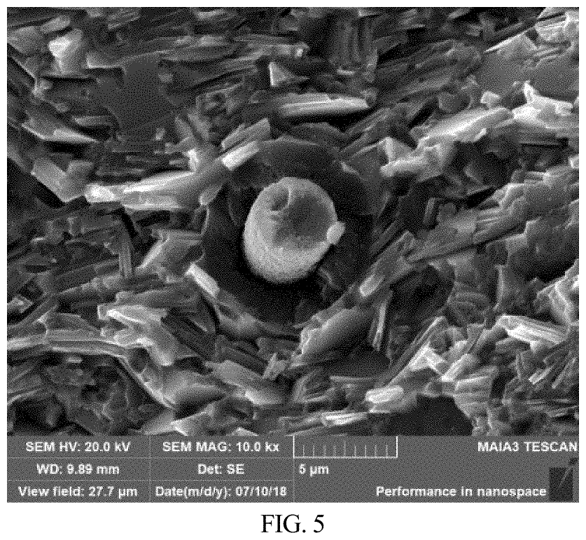

As shown in FIG. 4, it can also be seen from the fiber direction section of the nanocomposite ceramic material fiber that the reinforced short fibers are uniformly distributed in the MAX-phase ceramic matrix, and the axial direction of the short fibers is parallel to the nanosheet layered MAX-phase ceramic.

As shown in FIG. 5, it can be seen from the image of the fracture section of the nanocomposite ceramic material fiber that the fiber is well combined with the MAX-phase matrix, and in the microscopic attachment, the orientation of the MAX-phase matrix is slightly deformed and adjusted to completely wrap the fiber.

According to this embodiment, the high temperature strength of the composite material far exceeds that of pure Ti₂AlC/Al₂O₃ nanocomposite ceramics, and its high temperature mechanical properties: compressive strength reaches 50 MPa at 1200° C., which is much higher than the strength at 20-30 MPa of ordinary Ti₂AlC ceramics and Ti₂AlC/Al₂O₃ nanocomposite ceramics.

### Embodiment 2

According to this embodiment, a preparation method of MAX-phase ceramic matrix composite material with short fiber reinforced orientation is as follows:

Weigh 200 grams of MAX-phase ceramic nanosheet layered powder named Ti₃SiC₂, the particle size of the powder is 220 nanometers, and the oxygen content of the powder is 0.0002% by mass fraction. Weigh 50 grams of chopped silicon carbide fibers with a fiber diameter of 100˜200 microns and a fiber length of about 3-5 mm, and add 30 grams of SiC particles with a particle size of 50 nanometers as additives. Load the nanosheet layered powder, short fibers and SiC particles into the mixing machine directly, and a small amount of polyurethane-coated iron core balls with a diameter of 10 mm are added for mixing. The mixing tank a circular motion speed of 60 rpm and the mixing time is 4 hours, and argon gas is introduced into the mixing tank for protection. After the mixing is completed, in the vacuum glove box, the polyurethane iron core balls are sorted out to obtain a uniformly mixed material. The material is loaded into a hot isostatic pressing jacket, and then vacuum and weld to seal the jacket. Carry out hot isostatic pressing sintering, a sintering temperature is 1250° C., a sintering pressure is 150 MPa, the holding time is 120 minutes, and the heating rate is 5° C. per minute, and a sintering atmosphere is argon protection. After the sintering process, silicon carbide fiber-reinforced Ti₃SiC₂/SiC nano-composite ceramics is obtained, and the content of nano silicon carbide particles accounts for 10.6% of the material by mass fraction, silicon carbide fiber accounts for 17.8% of the material by mass fraction, the rest is Ti₃SiC₂, the orientation of the nanosheet layered MAX-phase ceramic matrix is that the direction of the sheet layer is parallel to the surface of the jacket, and the specification size of the nanosheet layered MAX-phase ceramic is 100˜400 nanometers in thickness and 1˜5 microns in width.

According to this embodiment, the high temperature strength of the composite material far exceeds that of pure Ti₃SiC₂/SiC nanocomposite ceramics, and its high temperature mechanical properties: compressive strength reaches 52 MPa at 1200° C., which is much higher than the strength at 20-30 MPa of ordinary Ti₃SiC₂ ceramics and Ti₃SiC₂/SiC nanocomposite ceramics.

### Embodiment 3

According to this embodiment, a preparation method of MAX-phase ceramic matrix composite material with short fiber reinforced orientation is as follows:

Weigh 200 grams of MAX-phase ceramic nanosheet layered powder named Ti₃AlC₂, the particle size of the powder is 200 nanometers, and the oxygen content of the powder is 0.0002% by mass fraction. Weigh 50 grams of chopped C fibers with a fiber diameter of 20˜50 microns and a fiber length of about 3-5 mm, and add 10 grams of polyethylene particles with a particle size of 50 nanometers as a reaction additive. Load the nanosheet layered powder, short fibers and polyethylene into the mixing machine directly, and a small amount of polyurethane-coated iron core balls with a diameter of 10 mm are added for mixing. The mixing tank a circular motion speed of 30 rpm and the mixing time is 12 hours, and argon gas is introduced into the mixing tank for protection. After the mixing is completed, in the vacuum glove box, the polyurethane iron core balls are sorted out to obtain a uniformly mixed material. The mixed material is loaded into a graphite mold, and hot-pressing sintering method is employed. Inside the graphite mold, the hot-pressing sintering is carried out, the sintering temperature 1250° C., the sintering pressure is 50 MPa, the holding time is 100 minutes, and the heating rate is 5° C. per minute, and the sintering atmosphere is argon protection. After the sintering process, carbon fiber-reinforced Ti₃AlC₂/TiC nano-composite ceramics is obtained, and the content of nano-titanium carbide particles accounts for 6% of the material by mass fraction, carbon fiber accounts for 20% of the material by mass fraction, the rest is Ti₃AlC₂, the orientation of the nanosheet layered MAX-phase ceramic matrix is that the direction of the sheet layer is parallel to the sintering pressing surface, and the specification size of the nanosheet layered MAX-phase ceramic is 100˜400 nanometers in thickness and 1˜10 microns in width.

According to this embodiment, the high temperature strength of the composite material far exceeds that of pure Ti₃AlC₂/TiC nanocomposite ceramics, and its high temperature mechanical properties: compressive strength reaches 60 MPa at 1200° C., which is much higher than the strength at 30-40 MPa of ordinary Ti₂AlC₂ ceramics and Ti₃AlC₂/TiC nanocomposite ceramics.

The results of the embodiments show that the fiber prepared by the method of the present invention is suitable for large-scale industrial preparation, and the performance is far superior to any existing known fiber MAX-phase composite material. Its technical route has good adaptability, good portability and broad application prospects.

1. A MAX-phase ceramic matrix composite material with short fiber reinforced orientation, characterized in that: the MAX-phase ceramic matrix composite material is prepared by a sintering process and has the following characteristics:
a matrix structure, formed by nanosheet layered MAX-phase ceramics, is highly oriented,
short fibers, which are arranged for reinforcement, are distributed in the matrix structure of the MAX-phase ceramics, and
an axial direction of the short fibers is parallel to the nanosheet layered MAX-phase ceramics.

2. The MAX-phase ceramic matrix composite material with short fiber reinforced orientation according to claim 1, characterized in that: the short fibers adopts short fibers obtained from a direct chemical synthesis, a continuous fibers with chopped cut treatment or raw cotton that is directly stirred into short fibers, wherein the short fibers obtained from the direct chemical synthesis are whiskers or nanowires, the short fibers obtained from the continuous fibers with chopped cut treatment are carbon fibers, silicon carbide fibers, glass fibers or boron fibers, and the raw cotton that is directly stirred into short fibers are alumina fiber raw cotton or glass fiber raw cotton.

3. The MAX-phase ceramic matrix composite material with short fiber reinforced orientation according to claim 2, characterized in that: a fiber diameter of the short fibers is 0.02-100 microns, and a fiber length of the short fibers is 0.1-5000 microns; a size of the nanosheet layered MAX-phase ceramics is 20-400 nanometers in thickness and 0.05-10 microns in width.

4. The MAX-phase ceramic matrix composite material with short fiber reinforced orientation according to claim 1, characterized in that: further comprising additives, the additives are dispersed in the matrix structure of the MAX-phase ceramics; the additives are components arranged to react with the MAX-phase ceramics to generate an in-situ ceramic phase, or are granular ceramic components added by an external source.

5. The MAX-phase ceramic matrix composite material with short fiber reinforced orientation according to claim 4, characterized in that:
the components arranged to react with the MAX-phase ceramics to generate an in-situ ceramic phase are elements C or organic matters, the granular ceramic components added by an external source are silicon carbide, alumina, aluminum nitride or titanium carbide, and a particle size of the granular ceramic components is 20-400 nanometers.

6. The MAX-phase ceramic matrix composite material with short fiber reinforced orientation according to claim 4, characterized in that: in the MAX-phase ceramic matrix composite material, a mass ratio of the short fibers, the nanosheet layered MAX-phase ceramics and the additives is (0.5-5):10:(0-5).

7. A preparation method of the MAX-phase ceramic matrix composite material with short fiber reinforced orientation according to claim 1, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.

8. The preparation method of the MAX-phase ceramic matrix composite material with short fiber reinforced orientation according to claim 7, characterized in that:
a sintering method which utilizes the mixture material or the embryo body directly for sintering with pressure, or a sintering method which utilizes the mixture material or the embryo body directly for pre-compression molding followed by sintering without pressure is employed.

9. The preparation method of the MAX-phase ceramic matrix composite material with short fiber reinforced orientation according to claim 8, characterized in that:
the sintering method which utilizes the mixture material or the embryo body directly for sintering with pressure employs a hot pressing sintering process, a hot isostatic pressing sintering process or a spark plasma sintering process, wherein
(1) the hot pressing sintering process:
the mixture material or the embryo body is directly loaded into a graphite mold, and inside the graphite mold, hot pressing sintering is carried out, a sintering temperature is 500˜2000° C., a sintering pressure is 1˜200 MPa, a holding time is 10˜3600 minutes, and a heating rate is 1˜100° C. per minute, and a sintering atmosphere is under vacuum or argon atmosphere;
(2) the hot isostatic pressing sintering process:
put the mixture material or the embryo body directly into the hot isostatic pressing jacket, and then vacuum and seal the jacket; inside the jacket, carry out hot isostatic pressing sintering, a sintering temperature is 500˜2000° C., a sintering pressure is 1˜800 MPa, the holding time is 10˜3600 minutes, and the heating rate is 1˜100° C. per minute, and a sintering atmosphere is under vacuum or argon atmosphere;
(3) the spark plasma sintering process:
put the mixture material or the embryo body directly into a sintering mold, and apply a large pulse current for sintering, a sintering temperature is 300˜1800° C., a sintering pressure is 1˜400 MPa, a holding time is 5˜600 minutes, a heating rate is 1˜500° C. per minute, and a sintering atmosphere is under vacuum or argon atmosphere.

10. The preparation method of the MAX-phase ceramic matrix composite material with short fiber reinforced orientation according to claim 8, characterized in that: the sintering method which utilizes the mixture material or the embryo body directly for pre-pressing molding followed by sintering without pressure employs one of the followings:
(1) put the mixture material or the embryo body into a pressing mold, apply pressure to the mold to process densification, a pressure applied is 5˜1000 MPa, and then obtain a pressed product of the mixture material or the embryo body to carry out sintering without pressure;
(2) put the mixture material or the embryo body into a cold isostatic pressing jacket, and then vacuum and seal the jacket; inside the jacket, process cold isostatic pressing sintering for densification, a cold isostatic pressing temperature is 0˜600° C., a cold isostatic pressing pressure is 1˜800 MPa, a holding time is 10˜3600 minutes, and a heating rate is 1˜100° C. per minute, then take out a pressed product of the mixture material or the embryo body from the jacket to carry out sintering without pressure;
(3) for carry out sintering without pressure with a pre-pressed product of the mixture material or the embryo body, a process of sintering without pressure is: put the mixture material or the embryo body into a container that can withstand a sintering temperature, and then vacuum the container or pass protective gas to the container, or put the mixture material or the embryo body directly into a furnace body that is vacuumed or passed with protective gas to carry out sintering without pressure inside the furnace;
an equipment used for sintering is a muffle furnace, an induction heating furnace, a microwave heating furnace, or an infrared heating furnace, a sintering temperature is 300 2000° C. and a sintering time is 10˜9600 minutes.

11. A preparation method of the MAX-phase ceramic matrix composite material with short fiber reinforced orientation according to claim 2, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.

12. A preparation method of the MAX-phase ceramic matrix composite material with short fiber reinforced orientation according to claim 3, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.

13. A preparation method of the MAX-phase ceramic matrix composite material with short fiber reinforced orientation according to claim 4, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.

14. A preparation method of the MAX-phase ceramic matrix composite material with short fiber reinforced orientation according to claim 5, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.

15. A preparation method of the MAX-phase ceramic matrix composite material with short fiber reinforced orientation according to claim 6, characterized in that: using the short fibers and the nanosheet layered MAX-phase ceramics in powder form as reaction raw materials, adding the additives according to the need, a mass ratio of the short fibers, the nanosheet layered MAX-phase ceramics and the additives is (0.5-5):10:(0-5), adding the raw materials into an organic solvent to prepare a raw material slurry, placing the raw material slurry into a mixer or other mixing equipment and then mixing uniformly, then drying to obtain a uniformly mixed mixture material, by using the mixture material or an embryo body prepared by pressing the mixture material, process sintering to prepare and obtain the MAX-phase ceramic matrix composite material.
